(19) United States
(12) Patent Application Publication
(10) Pub. No.: US 2014/0300620 A1
(43) Pub. Date: Oct. 9, 2014

(54) ADJUSTMENT DEVICE AND METHOD FOR ADJUSTING CHROMINANCE AND LUMINANCE OF DISPLAY DEVICE

(71) Applicant: FIH (Hong Kong) Limited, Kowloon (HK)

(72) Inventors: Li-Chieh CHENG, New Taipei (TW); Yi-Sheng HSU, New Taipei (TW); Wen-Hsin CHANG, New Taipei (TW)

(73) Assignee: FIH (Hong Kong) Limited, Kowloon (HK)

(21) Appl. No.: 14/201,983

(22) Filed: Mar. 10, 2014

(30) Foreign Application Priority Data
Apr. 3, 2013 (TW) 102112252

(51) Int. Cl. G09G 5/02; G06F 3/14; G06T 7/40

(52) U.S. Cl. CPC G09G 5/02; G06T 7/408; G06F 3/1446
USPC 345/590

(57) ABSTRACT

An adjustment device including a camera is connected to a display device. An image of a predetermined image displayed on the display device, and an image of a standard color image are captured by the camera. First chrominance differences and first luminance differences between the image corresponding to the standard color image and the standard color image are computed. Second chrominance differences and second luminance differences between the image corresponding to the predetermined image and the predetermined image are computed. Third chrominance differences between the first chrominance differences and the second chrominance differences, and third luminance differences between the first luminance differences and the second luminance differences are computed. According to third chrominance differences and third luminance differences, first adjustment data is obtained. The first adjustment data is sent to the display device. According to the first adjustment data, c. Chrominance and luminance of the display device is adjusted.

### BACKGROUND

1. Technical Field

Embodiments of the present disclosure relate to display adjustment technology, and particularly to an adjustment device and a method for adjusting chrominance and luminance of a display device.

2. Description of Related Art

Generally, chrominance and luminance of display devices needs manually adjusted by observing the display devices, therefore accuracy of the adjustment is low. If high accuracy is required for the chrominance and luminance of the display devices, expensive adjustment devices need to be used. In addition, when a display device includes a plurality of split screens, it is inconvenient for the users to adjust the chrominance and luminance of each screen.

### BRIEF DESCRIPTION OF THE DRAWINGS

FIG. 1 is a block diagram of one embodiment of an adjustment device including an adjustment system.

FIG. 2 is a block diagram of one embodiment of function modules of the adjustment system in the adjust device of FIG. 1.

FIG. 3 and FIG. 4 illustrate a flowchart of one embodiment of a method of adjusting chrominance and luminance of a display device in the adjustment device of FIG. 1.

FIG. 5 is a schematic diagram of a display device including nine split screens.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

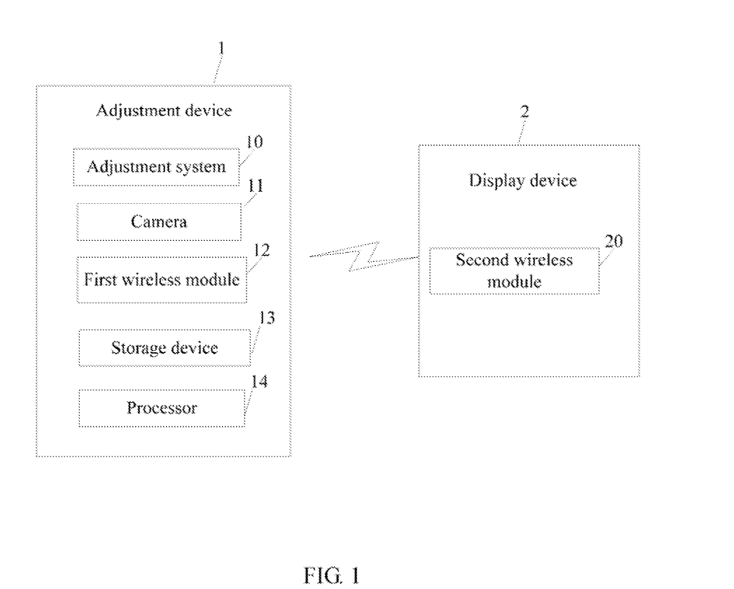

FIG. 1 is a block diagram of one embodiment of an adjustment device 1 including an adjustment system 10 (hereinafter “the system 10”). The adjustment device 1 further includes a camera 11, a first wireless module 12, a storage device 13, and a processor 14. The adjustment device 1 may be a computer, a smart phone or a personal digital assistant (PDA). FIG. 1 illustrates only one example of the adjustment device 1 that may include more or fewer components than illustrated, or have a different configuration of the various components in other embodiments.

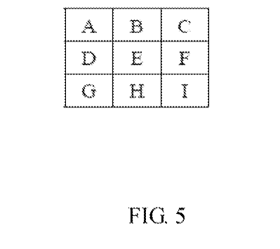

The adjustment device 1 is connected to a display device 2. The display device 1 includes at least one second wireless module 20. The adjustment device 1 communicates with the display device 2 using the first wireless component 12 and the second wireless component 20. The display device 2 may be a single screen or may include a plurality of split screens. As shown in FIG. 5, the display device 2 includes nine split screens, that is, A, B, C, D, E, F, G, H, I. Each split screen is a single screen.

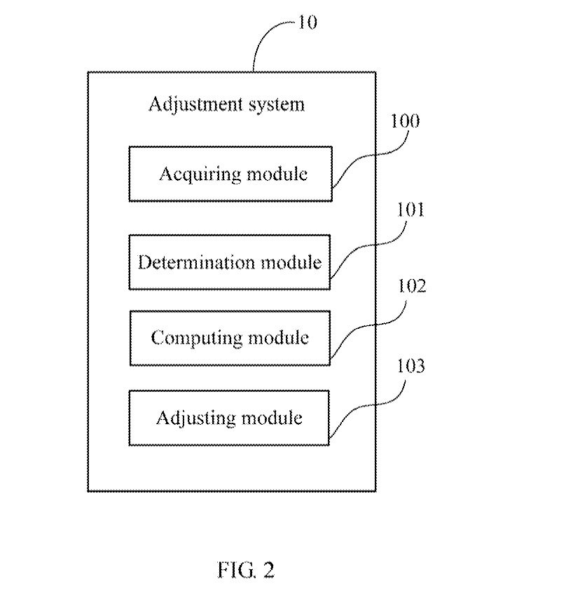

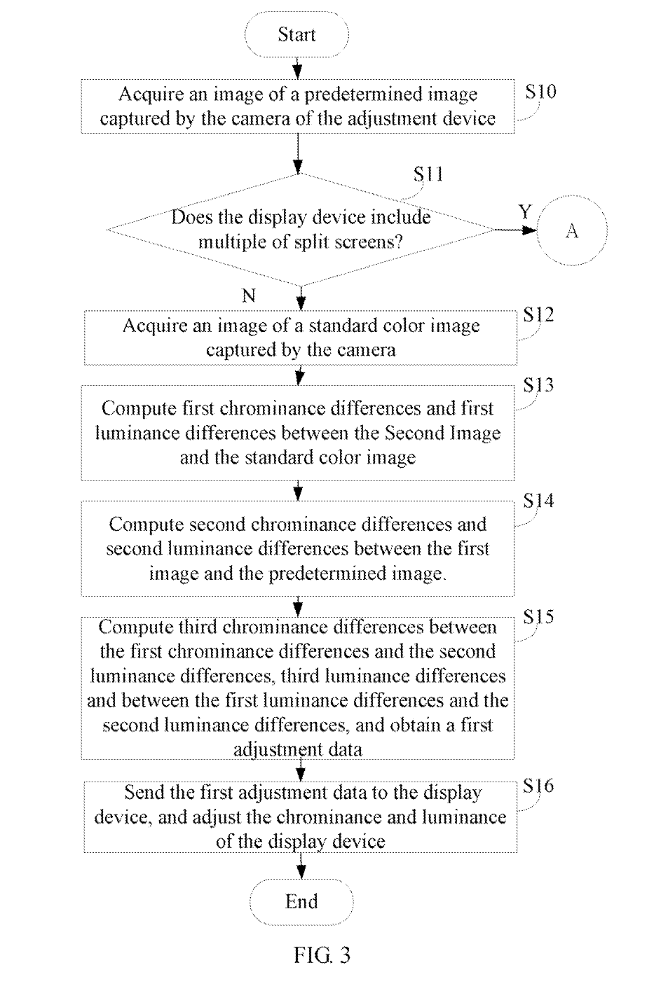

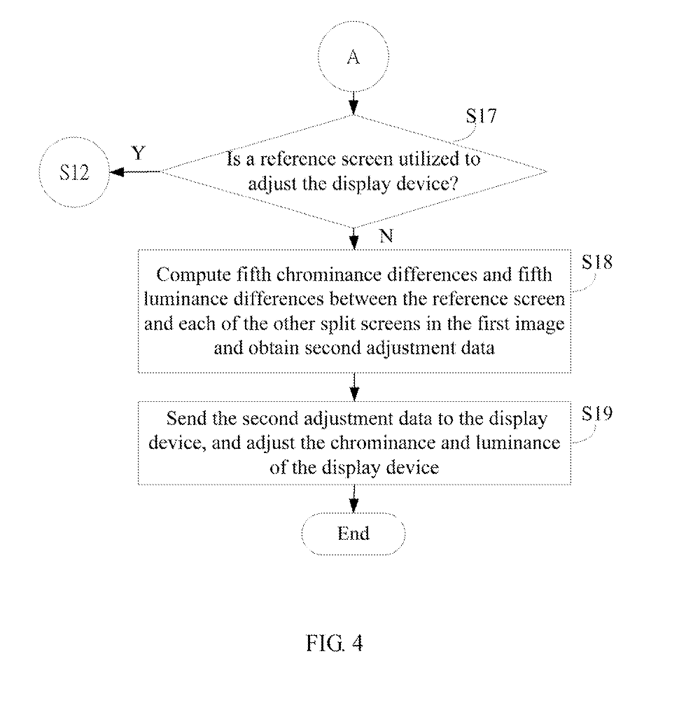

FIG. 2 is a block diagram of one embodiment of function modules of the system 10. In one embodiment, the system 10 may include an acquiring module 100, a determination module 101, a computing module 102, and an adjusting module 103. The function modules 100-103 may include computerized codes in the form of one or more programs, which are stored in the storage device 13. The processor 14 executes the computerized codes, to provide functions of the function modules 100-103. A detailed description of the function modules 100-103 is given in reference to FIG. 3 and FIG. 4.

FIG. 3 and FIG. 4 illustrate a flowchart of one embodiment of a method of adjusting chrominance and luminance of a display device using the adjustment device 1 of FIG. 1. Depending on the embodiment, additional steps may be added, others removed, and the ordering of the steps may be changed.

In step S10, the camera 11 captures an image of a predetermined image displayed on the display device 2, and the acquiring module 100 acquires the image of the predetermined image (hereinafter, the acquired image of the predetermined image is referred to as “the first image”) from the camera 11. The predetermined image can be any image which have a standard and known chrominance and luminance.

In step S11, the determination module 101 determines whether the display device 2 includes more than one split screen according to factory parameters of the display device 2. If the display device 2 does not include any split screens, the procedure goes to step S12. If the display device 2 includes more than one split screen, the procedure goes to step S17.

In step S12, the camera 11 is enabled to capture an image of a standard color image, and the acquiring module 100 acquires the image of the standard color image (hereinafter, the acquired image of the standard color image is referred to as “the second image”) from the camera 11. The standard color image may be a standard color card (e.g., a paper stand color card or an electronic stand color card displayed on the display device 2) or a specified image having standard and known chrominance and luminance. When the standard color image is the paper standard color card, chrominance and luminance of the standard color card are input in the adjustment device 1.

In step S13, the computing module 102 computes first chrominance differences and first luminance differences between the second image and the standard color image.

In step S14, the computing module 102 computes second chrominance differences and second luminance differences between the first image and the predetermined image.

In step S15, the computing module 102 computes third chrominance differences between the first chrominance differences and the second chrominance differences, and computes third luminance differences between the first luminance differences and the second luminance differences. Based on the third chrominance differences and the third luminance differences, the computing module 102 determines first adjustment data. For example, if a chrominance of the second image is 190, and a chrominance of the standard color image is 180, the first chrominance difference is “(190−180)”, that is 10. If a chrominance of the first image is 183 and a chrominance of the predetermined image is 190, the second chrominance difference is “(190−183)”, that is 7. Therefore, the third chrominance difference is “(10−7)” , that is 3. The value “3” of the third chrominance difference represents the chrominance of the display device 2 needs to be increased three chrominance units.

In step S16, the adjusting module 103 sends the first adjustment data to the display device 2, and adjusts the chrominance and luminance of the display device 2 according to the first adjustment data.

In other embodiments, a control program is installed in the display device 2. The adjusting module 103 sends the first adjustment data to the display device 2. The control program receives the first adjustment data, and adjusts the chrominance and luminance of the display device 2 according to the first adjustment data.

In step S17, the determination module 101 determines whether a reference screen is utilized to adjust the display device 1, according to an option selected by an user. If the option is “yes”, a reference screen is utilized to adjust the display device 1, the procedure goes to step S18. If the option is “no”, no reference screen is utilized to adjust the display device 1, the procedure returns to step S12.

In some embodiments, the reference screen is determined as follows. The determination module 101 computes fourth chrominance differences and fourth luminance differences between each split screen in the first image and a standard color image. The fourth chrominance differences and fourth luminance differences are stored in an array. The determination module 101 computes a total difference corresponding to each split screen by computing a sum of a fourth chrominance difference corresponding to each split screen and a fourth luminance difference corresponding to each split screen. The determination module 101 compares all total differences, and determines a least total difference. According to the least total difference, the determination module 101 determines a reference screen which corresponds to the least total difference.

In step S18, the computing module 102 computes fifth chrominance differences and fifth luminance differences between the reference screen and each of the other split screens in the first image. According to the fifth chrominance differences and fifth luminance differences, the computing module 102 determines second adjustment data.

In step S19, the adjusting module 103 sends the second adjustment data to the display device 2, and adjusts the chrominance and luminance of the display device 2 according to the second adjustment data.

In other embodiments, the control program receives the second adjustment data, and adjusts the chrominance and luminance of the display device 2 according to the second adjustment data.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for adjusting chrominance and luminance of a display device being executed by at least one processor of an adjustment device, the adjustment device in connection to the display device, the method comprising:
acquiring an image of a predetermined image displayed on the display device captured by a camera of the adjustment device;
acquiring an image of a standard color image captured by the camera;
computing first chrominance differences and first luminance differences between the acquired image corresponding to the standard color image and the standard color image;
computing second chrominance differences and second luminance differences between the acquired image corresponding to the predetermined image and the predetermined image;
computing third chrominance differences between the first chrominance differences and the second chrominance differences and computing third luminance differences between the first luminance differences and the second luminance differences, and obtaining first adjustment data according to the third chrominance differences and the third luminance differences; and
sending the first adjustment data to the display device, and adjusting the chrominance and luminance of the display device according to the first adjustment data.

2. The method according to claim 1, wherein a step of determining the reference screen comprises:
computing fourth chrominance differences and fourth luminance differences between each split screen in the first image and a standard color image;
computing a total difference corresponding to each split screen by computing a sum of a fourth chrominance difference corresponding to each split screen and a fourth luminance difference corresponding to each split screen;
comparing all total differences, and determining a least total difference; and
determining a reference screen which corresponds to the least total difference.

3. The method according to claim 2, the method comprising:
computing fifth chrominance differences and fifth luminance differences between the reference screen and each of the other split screens in the acquired image corresponding to the predetermined image, and obtaining second adjustment data according to the fifth chrominance differences and fifth luminance differences; and
sending the second adjustment data to the display device, and adjusting the chrominance and the luminance of the display device according to the second adjustment data.

4. The method according to claim 1, wherein the predetermined image has standard and known chrominance and luminance.

5. The method according to claim 1, wherein the standard color image is a standard color card or a specified image having standard and known chrominance and luminance.

6. The method according to claim 1, wherein the display device comprises a wireless module, and the display device communicates with the adjustment device using the wireless module.

7. An adjustment device, comprising:
a processor; and
a storage device that stores one or more programs, when executed by the at least one processor, cause the at least one processor to perform an adjustment method, the adjustment device in connection to the display device, the method comprising:
acquiring an image of a predetermined image displayed on the display device captured by a camera of the adjustment device;
acquiring an image of a standard color image captured by the camera;
computing first chrominance differences and first luminance differences between the acquired image corresponding to the standard color image and the standard color image;
computing second chrominance differences and second luminance differences between the acquired image corresponding to the predetermined image and the predetermined image;
computing third chrominance differences between the first chrominance differences and the second chrominance differences and computing third luminance differences between the first luminance differences and the second luminance differences, and obtaining first adjustment data according to the third chrominance differences and the third luminance differences; and
sending the first adjustment data to the display device, and adjusting the chrominance and luminance of the display device according to the first adjustment data.

8. The adjustment device according to claim 7, wherein a step of determining the reference screen comprises:
computing fourth chrominance differences and fourth luminance differences between each split screen in the first image and a standard color image;
computing a total difference corresponding to each split screen by computing a sum of a fourth chrominance difference corresponding to each split screen and a fourth luminance difference corresponding to each split screen;
comparing all total differences, and determining a least total difference; and
determining a reference screen which corresponds to the least total difference.

9. The adjustment device according to claim 8, the method comprising:
computing fifth chrominance differences and fifth luminance differences between the reference screen and each of the other split screens in the acquired image corresponding to the predetermined image, and obtaining second adjustment data according to the fifth chrominance differences and fifth luminance differences; and
sending the second adjustment data to the display device, and adjusting the chrominance and the luminance of the display device according to the second adjustment data.

10. The adjustment device according to claim 7, wherein the predetermined image has standard and known chrominance and luminance.

11. The adjustment device according to claim 7, wherein the standard color image is a standard color card or a specified image having standard and known chrominance and luminance.

12. The adjustment device according to claim 7, wherein the display device comprises a wireless module, and the display device communicates with the adjustment device using the wireless module.

13. A non-transitory storage medium having stored thereon instructions that, when executed by a processor of an adjustment device, the adjustment device in connection to the display device, wherein the method comprises:
acquiring an image of a predetermined image displayed on the display device captured by a camera of the adjustment device;
acquiring an image of a standard color image captured by the camera;
computing first chrominance differences and first luminance differences between the acquired image corresponding to the standard color image and the standard color image;
computing second chrominance differences and second luminance differences between the acquired image corresponding to the predetermined image and the predetermined image;
computing third chrominance differences between the first chrominance differences and the second chrominance differences and computing third luminance differences between the first luminance differences and the second luminance differences, and obtaining first adjustment data according to the third chrominance differences and the third luminance differences; and
sending the first adjustment data to the display device, and adjusting the chrominance and luminance of the display device according to the first adjustment data.

14. The non-transitory storage medium according to claim 13, wherein a step of determining the reference screen comprises:
computing fourth chrominance differences and fourth luminance differences between each split screen in the first image and a standard color image;
computing a total difference corresponding to each split screen by computing a sum of a fourth chrominance difference corresponding to each split screen and a fourth luminance difference corresponding to each split screen;
comparing all total differences, and determining a least total difference; and
determining a reference screen which corresponds to the least total difference.

15. The non-transitory storage medium according to claim 14, the method comprising:
computing fifth chrominance differences and fifth luminance differences between the reference screen and each of the other split screens in the acquired image corresponding to the predetermined image, and obtaining second adjustment data according to the fifth chrominance differences and fifth luminance differences; and
sending the second adjustment data to the display device, and adjusting the chrominance and the luminance of the display device according to the second adjustment data.

16. The non-transitory storage medium according to claim 13, wherein the predetermined image has standard and known chrominance and luminance.

17. The non-transitory storage medium according to claim 13, wherein the standard color image is a standard color card or a specified image having standard and known chrominance and luminance.

18. The non-transitory storage medium according to claim 13, wherein the display device comprises a wireless module, and the display device communicates with the adjustment device using the wireless module.
